(19) United States
(12) Patent Application Publication
(10) Pub. No.: US 2013/0007356 A1
(43) Pub. Date: Jan. 3, 2013

(54) Assigning A Classification To A Dual In-line Memory Module (DIMM)

(75) Inventors: Newton P. Liu, Austin, TX (US); Thanh Nguyen, Austin, TX (US); Terence Rodrigues, Austin, TX (US); Robert K. Sloan, Pflugerville, TX (US); Mark W. Wenning, Cedar Park, TX (US)

(73) Assignee: INTERNATIONAL BUSINESS MACHINES CORPORATION, Armonk, NY (US)

(21) Appl. No.: 13/173,404

(22) Filed: Jun. 30, 2011

(51) Int. Cl. G06F 12/06

(52) U.S. Cl. 711/105; 711/E12.078

(57) ABSTRACT

Methods, apparatuses, and computer program products for assigning a classification to a dual in-line memory module (DIMM) are provided. Embodiments include determining, by a modifier, a classification of a DIMM; and providing a visual indication of the determined classification of the DIMM, including modifying, by the modifier, a top edge of a printed circuit board of the DIMM.

### BACKGROUND OF THE INVENTION

1. Field of the Invention

The field of the invention is data processing, or, more specifically, methods, apparatus, and products for assigning a classification to a dual in-line memory module (DIMM).

2. Description of Related Art

Dual in-line memory modules (DIMMs) may come in many different sizes, types, ranks, and have any number of variations of organization of memory chips on the DIMM. A system may require an inserted DIMM pair to be comprised of compatible DIMMs. For example, a system may not allow a DIMM pair that includes incompatible ranks, such as a pairing of a 2 GB dual rank DIMM and a 2 GB single rank DIMM. In order to ensure that a DIMM pair is comprised of compatible DIMMs, an administrator of the system may compare the DIMM information corresponding to each DIMM in the pair to determine if the DIMM information matches. Typically, DIMM information is located on a very small font on a sticker that may be removed, and thus is not easy to identify compatible DIMMs.

### SUMMARY OF THE INVENTION

Methods, apparatuses, and computer program products for assigning a classification to a dual in-line memory module (DIMM) are provided. Embodiments include determining, by a modifier, a classification of a DIMM; and providing a visual indication of the determined classification of the DIMM, including modifying, by the modifier, a top edge of a printed circuit board of the DIMM.

A method of comparing assigned classifications of at least two dual in-line memory modules (DIMMs) is provided. Embodiments include stacking a first DIMM on a second DIMM such that a modified edge of a printed circuit board of the first DIMM is aligned with a modified edge of a printed circuit board of the second DIMM, the modified edge of the first DIMM providing a visual indication of a classification of the first DIMM and the modified edge of the second DIMM providing a visual indication of a classification of the second DIMM; and determining whether the modified edge of the first DIMM matches the modified edge of the second DIMM; if the modified edge of the first DIMM does not match the modified edge of the second DIMM, determining that the classification of the first DIMM is different than the classification of the second DIMM; and if the modified edge of the first DIMM matches the modified edge of the second DIMM, determining that the classification of the first DIMM is the same as the classification of the second DIMM.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth an unmodified dual in-line memory module and a modified dual in-line memory module assigned a classification according to embodiments of the present invention.

FIG. 2 sets forth a diagram of automated computing machinery comprising an exemplary computer useful for assigning a classification to a dual in-line memory module in according to embodiments of the present invention.

FIG. 3 sets forth a flow chart illustrating an exemplary method for assigning a classification to a dual in-line memory module according to embodiments of the present invention.

FIG. 4 sets forth a flow chart illustrating an exemplary method for comparing assigned classifications of at least two dual in-line memory modules according to embodiments of the present invention.

### DETAILED DESCRIPTION OF EXEMPLARY EMBODIMENTS

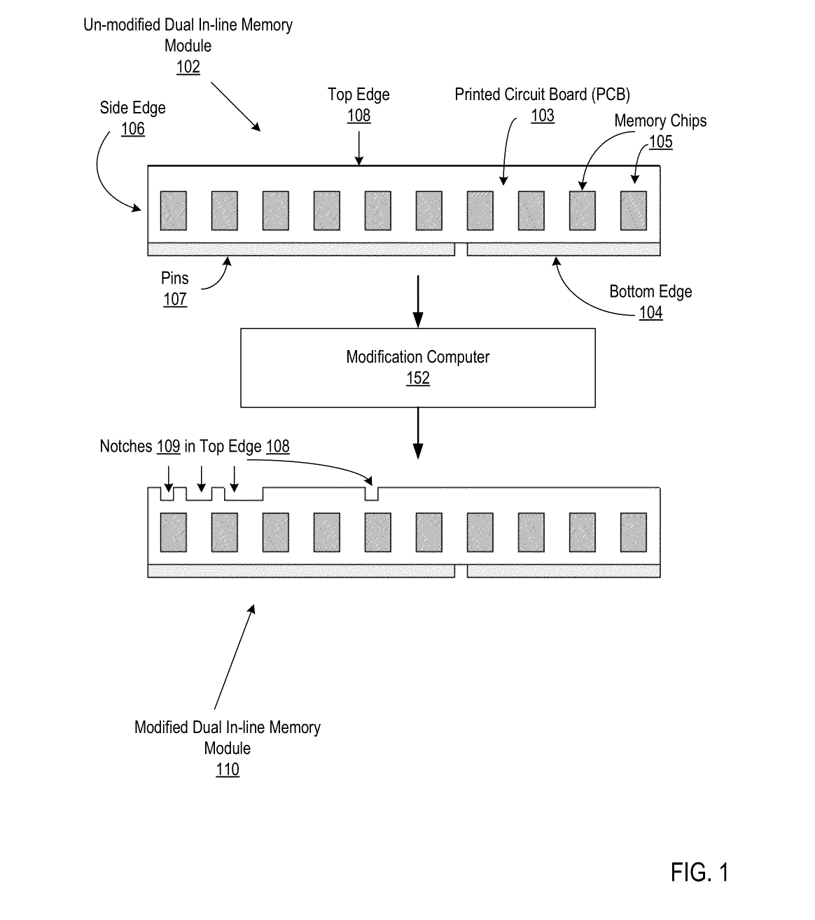

Exemplary methods, apparatuses, and computer program products for assigning a classification to a dual in-line memory module (DIMM) in accordance with the present invention are described with reference to the accompanying drawings, beginning with FIG. 1. FIG. 1 sets forth an unmodified dual in-line memory module (102) and a modified dual in-line memory module (110) assigned a classification according to embodiments of the present invention.

Both the unmodified DIMM (102) and the modified DIMM (110) of FIG. 1 include memory chips (105) mounted on a printed circuit board (PCB) (103). The memory chips (105) may be dynamic random access memory integrated circuits. A PCB is used to mechanically support and electrically connect electrical components using conductive pathways, tracks or signal traces etched from copper sheets laminated onto a non-conductive substrate. The PCBs (103) of the DIMMs (102, 110) include pins (107) along the bottom edge (104) of the PCB (103). Pins on a DIMM are used to connect the DIMM to a component of a system. As illustrated in FIG. 1, the side edges (106) and the top edge (108) do not include notches or pins.

In the example of FIG. 1, a modification computer (152) modifies the un-modified DIMM (102). Modifying the un-modified DIMM (102) includes assigning a classification to the un-modified DIMM (102). A classification of a particular DIMM may include a particular size, type, rank, an organization of the memory chips on the PCB (103). As part of the process of assigning a classification to the DIMM (102), the modification computer (152) of FIG. 1 is configured to determine a classification of a particular DIMM. Determining the classification of the particular DIMM may be done by a user of the modification computer (152) manually entering the classification for the particular DIMM into the modification computer (152), or in any other way that one of skill in the art would determine that a classification for a DIMM. For example, a user of the modification computer (152) may read DIMM information located on the un-modified DIMM (102) and enter the DIMM information into the modification computer (152).

The modification computer (152) of FIG. 1 is also configured to provide a visual indication of the determined classification of the DIMM. In the example of FIG. 1, providing a visual indication of the determined classification may be carried out by modifying, by the modification computer (152), the top edge (108) of the PCB (103) of the DIMM (102). As illustrated in FIG. 1, this modification includes removing one or more portions of the top edge (105) of the PCB (103), generating a pattern of notches (109) along the top edge (105) of the PCB (103) of the DIMM (110). The notches (109) may be a distinct indication of the classification of the modified DIMM (110). For example, an administrator attempting to find compatible DIMMs to insert into a system may examine the physical geometry of notches along the top edge of the modified DIMM (110) and based on the examination, determine whether the classifications of the DIMMs are compatible. In addition, this tactile inspection of the DIMMs by the administrator may be advantageously performed without the need of powering the DIMM on, reading English, impairment of sight or low-level light.

As part of the processing of modifying a DIMM, the modification computer (152) may act as a design computer that modifies a design of the DIMM. That is, modifying a DIMM may include modifying PCB design information corresponding to a DIMM, physically cutting out sections of PCB in a DIMM, or some combination thereof. The PCB design information may include physical positioning information of a packaged semiconductor device of the PCB. The modification computer (152) may be configured to transform the PCB design information to generate a data file, such as a GERBER file with data that includes new physical positioning information of the PCB, as well as layout of electrical connections such as traces and vias. The new physical positioning information may indicate the notches (109) that are removed from the DIMM (102). That is, the modification computer (152) may generate a new PCB design to create the modified DIMM (110) illustrated in FIG. 1. In other embodiments, the data file generated by the transformed PCB design information may have a format other than a GERBER format. The GERBER file may be received at some board assembly process that is used to create PCBs manufactured in accordance with the design information stored within the GERBER file. For example, the GERBER file may be uploaded to one or more machines to perform various steps of a PCB production process. The PCB may be populated with electronic components to form the PCB (103) of the DIMM (110).

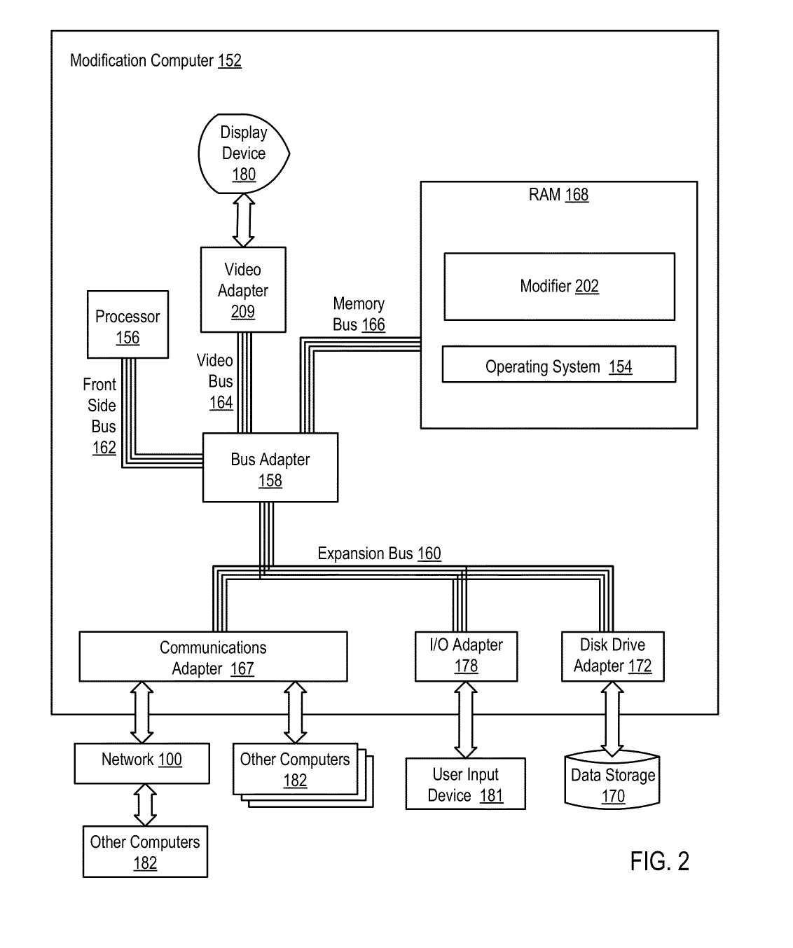

Assigning a classification to a dual in-line memory module in accordance with the present invention is generally implemented with computers, that is, with automated computing machinery. In the system of FIG. 1, for example, the modification computer is implemented as a computer. For further explanation, therefore, FIG. 2 sets forth a block diagram of automated computing machinery comprising an exemplary modification computer (152) useful in assigning a classification to a DIMM according to embodiments of the present invention. The modification computer (152) of FIG. 2 includes at least one computer processor (156) or ‘CPU’ as well as random access memory (168) (RAM') which is connected through a high speed memory bus (166) and bus adapter (158) to processor (156) and to other components of the modification computer (152).

Stored in RAM (168) is a modifier (202) which includes computer program instructions for assigning a classification to a dual in-line memory module (DIMM). The computer program instruction of the modifier (202) are capable, when executed, of causing the computer (152) to carry out the steps of: determining, by a modifier, a classification of a DIMM; and providing a visual indication of the determined classification of the DIMM, including modifying, by the modifier, a top edge of a printed circuit board of the DIMM. As explained above, modifying a DIMM may include modifying PCB design information corresponding to a DIMM, physically cutting out sections of PCB in a DIMM, or some combination thereof.

Also stored in RAM (168) is an operating system (154). Operating systems useful assigning a classification to a dual in-line memory module (DIMM) according to embodiments of the present invention include UNIX™, Linux™, Microsoft XP™, AIX™, IBM's i5/OS™, and others as will occur to those of skill in the art. The operating system (154) and the modifier (202) in the example of FIG. 2 are shown in RAM (168), but many components of such software typically are stored in non-volatile memory also, such as, for example, on a disk drive (170).

The modification computer (152) of FIG. 2 includes a disk drive adapter (172) coupled through an expansion bus (160) and a bus adapter (158) to the processor (156) and other components of the modification computer (152). The disk drive adapter (172) connects non-volatile data storage to the modification computer (152) in the form of a disk drive (170). Disk drive adapters useful in computers for assigning a classification to a dual in-line memory module (DIMM) according to embodiments of the present invention include Integrated Drive Electronics (‘IDE’) adapters, Small Computer System Interface (SCSI') adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example modification computer (152) of FIG. 2 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 2 includes a video adapter (209), which is an example of an I/O adapter specially designed for graphic output to a display device (180) such as a display screen or computer monitor. The video adapter (209) is connected to the processor (156) through a high speed video bus (164), the bus adapter (158), and a front side bus (162), which is also a high speed bus.

The exemplary modification computer (152) of FIG. 2 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for assigning a classification to a dual in-line memory module (DIMM) according to embodiments of the present invention include modems for wired dial-up communications, Ethernet (IEEE 802.3) adapters for wired data communications network communications, and 802.11 adapters for wireless data communications network communications.

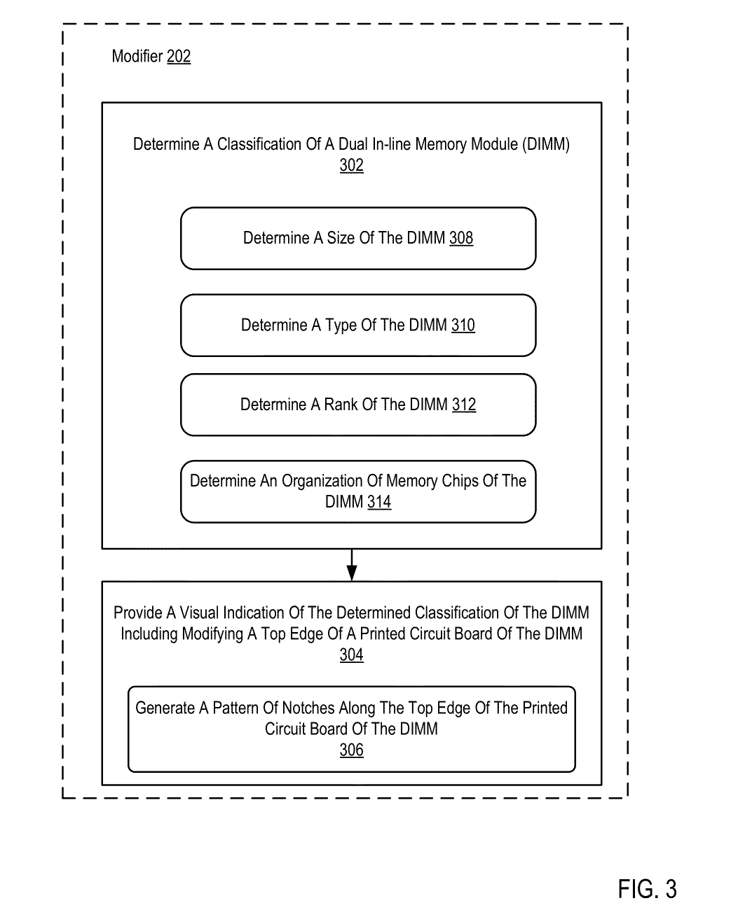

For further explanation, FIG. 3 sets forth a flow chart illustrating an exemplary method for assigning a classification to a dual in-line memory module (DIMM) according to embodiments of the present invention. The method of FIG. 3 includes determining (302), by a modifier (202), a classification of a DIMM. Determining (302) a classification of a DIMM may be carried out by receiving the classification of the DIMM from a user of the modifier (202). For example, a user may read DIMM information from a DIMM and enter the DIMM information into the modifier (202).

In the example of FIG. 3, determining (302) a classification of the DIMM includes determining (308) a size of the DIMM, determining (310) a type of the DIMM, determining (312) a rank of the DIMM, and determining (314) an organization of memory chips of the DIMM. A size of the DIMM corresponds to a capacity of the DIMM, such as 1 GB, 2 GB, 4 GB, etc. Different types of DIMM may include DDR1, DDR2, and ect. A particular DIMM may also be classified as single rank, dual rank, quad rank, and ect. The organization of memory chips of a DIMM may include a number of memory chips on a particular DIMM, where the memory chips are located, or some combination thereof.

The method of FIG. 3 also includes providing (304), by the modifier (202), a visual indication of the determined classification of the DIMM. Providing (302) a visual indication of the determined classification may be carried out by modifying, by the modification computer (152), the top edge (108) of the PCB (103) of the DIMM (102). As illustrated in FIG. 1, this modification includes removing one or more portions of the top edge (105) of the PCB (103), generating a pattern of notches (109) along the top edge (105) of the PCB (103) of the DIMM (110). The notches (109) may be geometric cutouts of the PCB indicating a distinct indication of the classification of the modified DIMM (110). As explained above, modifying a DIMM according to embodiments of the current invention may include modifying PCB design information corresponding to a DIMM as well as physically removing sections of PCB in a DIMM to form the geometric cutouts along the top edge of the DIMM.

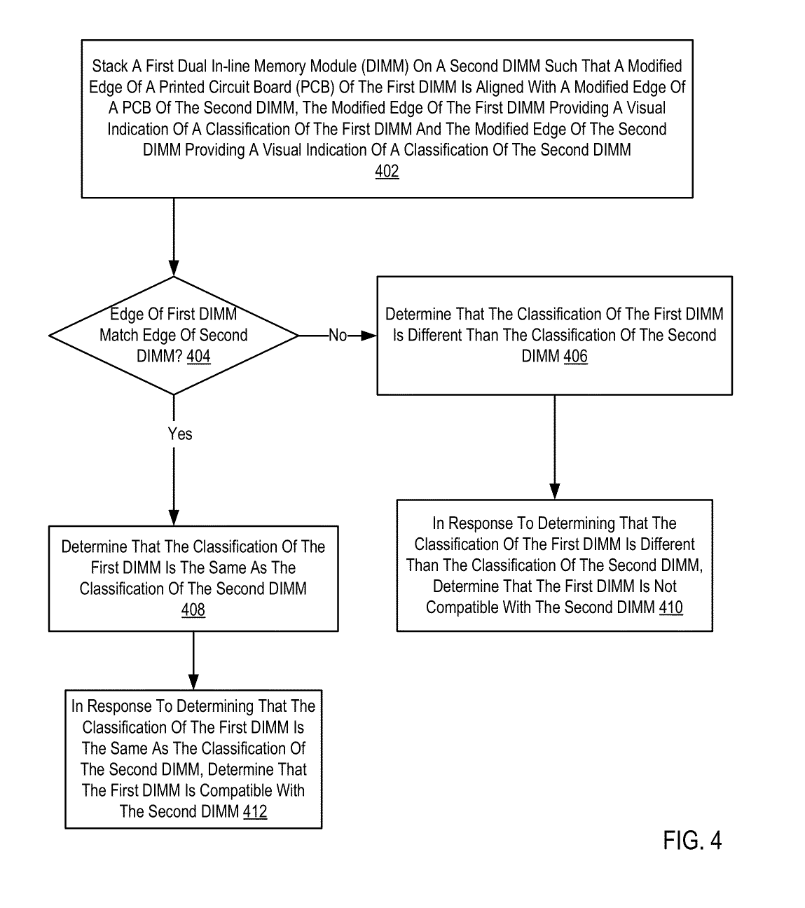

For further explanation, FIG. 4 sets forth a flow chart illustrating a further exemplary method for assigning a classification to a dual in-line memory module (DIMM) according to embodiments of the present invention. The method of FIG. 4 includes stacking (402) a first DIMM on a second DIMM such that a modified edge of a printed circuit board (PCB) of the first DIMM is aligned with a modified edge of a PCB of the second DIMM. The modified edge of the first DIMM provides a visual indication of a classification of the first DIMM and the modified edge of the second DIMM provides a visual indication of a classification of the second DIMM.

The method of FIG. 4 includes determining (404) whether the modified edge of the first DIMM matches the modified edge of the second DIMM. Determining (404) whether the modified edge of the first DIMM matches the modified edge of the second DIMM may be carried out by determining if any of the notches on the top edge of the one of the DIMMs is covered up or unaligned with another notch on the top edge of another of the DIMMs.

If the modified edge of the first DIMM does not match the modified edge of the second DIMM, the method FIG. 4 includes determining (406) that the classification of the first DIMM is different than the classification of the second DIMM. The method of FIG. 4 also includes in response to determining that the classification of the first DIMM is different than the classification of the second DIMM, determining that the first DIMM is not compatible with the second DIMM.

If the modified edge of the first DIMM matches the modified edge of the second DIMM, the method of FIG. 4 includes determining (408) that the classification of the first DIMM is substantially the same as the classification of the second DIMM. The method of FIG. 4 also includes in response to determining that the classification of the first DIMM is the same as the classification of the second DIMM, determining that the first DIMM is compatible with the second DIMM.

In a particular embodiment, different sections of notches along the top edge of the modified DIMM may correspond with different classifications. For example, one section of notches may indicate a type of the DIMM and a second section of notches may be reserved for indicating a rank of the DIMM. Therefore, an administrator attempting to find a compatible DIMM pair may inspect particular sections relevant to compatibility. For example, if a system requires a DIMM pair to have matching rank and type, the administrator may inspect both the rank section of notches and the type section of notches to determine if both sections of a candidate pair of DIMMs substantially match. As another example, if a system only requires a DIMM pair to have matching rank, then the administrator may quickly identify whether the rank sections match without inspecting or regarding as to whether the notches of the type of sections are substantially matched. This tactile inspection of the DIMMs by the administrator may be advantageously performed without the need of powering the DIMM on, reading English, impairment of sight or low-level light. Therefore, an administrator with a visual impairment may be able to perform this inspection.

Exemplary embodiments of the present invention are described largely in the context of a fully functional computer system for assigning a classification to a dual in-line memory module (DIMM). Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of assigning a classification to a dual in-line memory module (DIMM), the method comprising:
determining, by a modifier, a classification of a DIMM; and
providing a visual indication of the determined classification of the DIMM, including modifying, by the modifier, a top edge of a printed circuit board of the DIMM.

2. The method of claim 1 wherein modifying the top edge of the DIMM includes removing, by the modifier one or more portions of the top edge, generating a pattern of notches along the top edge of the printed circuit board of the DIMM.

3. The method of claim 1 wherein determining the classification of the DIMM includes determining, by the modifier, a size of the DIMM; and wherein the provided visual indication of the determined classification of the DIMM indicates the determined size of the DIMM.

4. The method of claim 1 wherein determining the classification of the DIMM includes determining, by the modifier, a type of the DIMM; and wherein the provided visual indication of the determined classification of the DIMM indicates the determined type of the DIMM.

5. The method of claim 1 wherein determining the classification of the DIMM includes determining, by the modifier, a rank of the DIMM; and wherein the provided visual indication of the determined classification of the DIMM indicates the determined rank of the DIMM.

6. The method of claim 1 wherein determining the classification of the DIMM includes determining, by the modifier, an organization of memory chips of the DIMM; and wherein the provided visual indication of the determined classification of the DIMM indicates the determined organization of memory chips of the DIMM.

7. Apparatus for assigning a classification to a dual in-line memory module (DIMM), the apparatus comprising a computer processor, a computer memory operatively coupled to the computer processor, the computer memory having disposed within it computer program instructions capable of:
determining, by a modifier, a classification of a DIMM; and
providing a visual indication of the determined classification of the DIMM, including modifying, by the modifier, a top edge of a printed circuit board of the DIMM.

8. The apparatus of claim 7 wherein modifying the top edge of the DIMM includes removing, by the modifier one or more portions of the top edge, generating a pattern of notches along the top edge of the printed circuit board of the DIMM.

9. The apparatus of claim 7 wherein determining the classification of the DIMM includes determining, by the modifier, a size of the DIMM; and wherein the provided visual indication of the determined classification of the DIMM indicates the determined size of the DIMM.

10. The apparatus of claim 7 wherein determining the classification of the DIMM includes determining, by the modifier, a type of the DIMM; and wherein the provided visual indication of the determined classification of the DIMM indicates the determined type of the DIMM.

11. The apparatus of claim 7 wherein determining the classification of the DIMM includes determining, by the modifier, a rank of the DIMM; and wherein the provided visual indication of the determined classification of the DIMM indicates the determined rank of the DIMM.

12. The apparatus of claim 7 wherein determining the classification of the DIMM includes determining, by the modifier, an organization of memory chips of the DIMM; and wherein the provided visual indication of the determined classification of the DIMM indicates the determined organization of memory chips of the DIMM.

13. A computer program product for assigning a classification to a dual in-line memory module (DIMM), the computer program product disposed upon a computer readable storage medium, the computer program product comprising computer program instructions capable, when executed, of causing a computer to carry out the steps of:
determining, by a modifier, a classification of a DIMM; and
providing a visual indication of the determined classification of the DIMM, including modifying, by the modifier, a top edge of a printed circuit board of the DIMM.

14. The computer program product of claim 13 wherein modifying the top edge of the DIMM includes removing, by the modifier one or more portions of the top edge, generating a pattern of notches along the top edge of the printed circuit board of the DIMM.

15. The computer program product of claim 13 wherein the classification of a DIMM indicates at least one of size, type, rank, and organization of memory chips within a particular DIMM.

16. A method of comparing assigned classifications of at least two dual in-line memory modules (DIMMs), the method comprising:
stacking a first DIMM on a second DIMM such that a modified edge of a printed circuit board (PCB) of the first DIMM is aligned with a modified edge of a PCB of the second DIMM, the modified edge of the first DIMM providing a visual indication of a classification of the first DIMM and the modified edge of the second DIMM providing a visual indication of a classification of the second DIMM;
determining whether the modified edge of the first DIMM matches the modified edge of the second DIMM;
if the modified edge of the first DIMM does not match the modified edge of the second DIMM, determining that the classification of the first DIMM is different than the classification of the second DIMM; and
if the modified edge of the first DIMM matches the modified edge of the second DIMM, determining that the classification of the first DIMM is the same as the classification of the second DIMM.

17. The method of claim 16 further comprising in response to determining that the classification of the first DIMM is different than the classification of the second DIMM, determining that the first DIMM is not compatible with the second DIMM.

18. The method of claim 16 further comprising in response to determining that the classification of the first DIMM is the same as the classification of the second DIMM, determining that the first DIMM is compatible with the second DIMM.

19. The method of claim 16 wherein the classification of a DIMM indicates at least one of size, type, rank, and organization of memory chips within a particular DIMM.

20. The method of claim 16 wherein the visual indication comprises a pattern of notches on the top edge of the printed circuit board of a particular DIMM.
